(19) United States
(12) Patent Application Publication
(10) Pub. No.: US 2012/0103495 A1
(43) Pub. Date: May 3, 2012

(54) TIRE AND WHEEL FOR A CYCLE

(75) Inventors: Jean-Pierre MERCAT, Chavanod (FR); François-Xavier HUAT, Annecy (FR)

(73) Assignee: MAVIC S.A.S., Metz-Tessy (FR)

(21) Appl. No.: 13/284,228

(22) Filed: Oct. 28, 2011

(30) Foreign Application Priority Data
Oct. 29, 2010 (FR) 10.02959
Oct. 29, 2010 (FR) 10/04259

(51) Int. Cl. B60C 13/02

(52) U.S. Cl. 152/523

(57) ABSTRACT

A tire for the wheel of a cycle, such as a bicycle, as well as a wheel equipped with such a tire, the tire having a substantially toroidal geometry and including a mounting base adapted to be fixed to a rim that is wider than the tire, when inflated, a tread adapted to be in contact with the ground, and two sidewalls connecting the mounting base to the tread. The tire is provided, between each sidewall and the tread, with a spoiler for retaining a closed loop air circulation, whereby aerodynamic resistance is reduced.

### CROSS-REFERENCE TO RELATED APPLICATION

This application is based upon French patent application Ser. No. 10/04259, filed Oct. 29, 2010, the disclosure of which is hereby incorporated by reference thereto in its entirety, and the priority of which is claimed under 35 U.S.C. §119.

### BACKGROUND OF THE INVENTION

1. Field of the Invention

The present invention relates to a tire for a cycle wheel and a cycle wheel in combination with, or equipped with, such tire.

2. Background Information

The mechanical power that a human being can generate is limited. In particular, the forward speed of a cycle, such as a bicycle, is limited by the power that the cyclist can develop. This forward speed is degraded by drag forces, which include rolling resistance, which is a linear function of speed, and aerodynamic resistance or drag, which is a function of speed squared. Aerodynamic theory teaches that the more laminar the airflow around a moving object, the lower its aerodynamic resistance. Conversely, when a moving object has a geometry that generates airflow separation along its surface, its forward movement causes the formation of vortices that tend to increase the drag and, therefore, reduce the forward speed of such object.

U.S. Pat. No. 5,061,013 discloses a bicycle wheel comprising a rim and a pneumatic tire, the geometry and proportions of which make it possible to reduce the aerodynamic resistance of the wheel to a certain extent. However, in the area of a peripheral junction zone between the rim and the tire, the wheel has cavities with surfaces that oppose the flow of air along the wheel, which increases the aerodynamic resistance of the wheel. When such a wheel is subject to an airflow, vortices are formed in the area of this junction zone, which tends to reduce the forward speed of a cycle equipped with such a wheel.

### SUMMARY

The invention overcomes the aforementioned drawbacks providing a tire for a cycle wheel, such as a pneumatic tire, and a cycle wheel equipped with such a tire, in which aerodynamic resistance is reduced.

To this end, the invention relates to a tire for a cycle wheel, such as a pneumatic tire, having a substantially toroidal geometry and comprising a mounting base adapted to be fixed to a rim, a tread adapted to be in contact with the ground, and two sidewalls connecting the mounting base to the tread, the tire being further provided, between each sidewall and the tread, with a spoiler, i.e., an airflow deflector or guide, for retaining a closed loop air circulation.

Due to the invention, when a wheel equipped with such a tire is subject to an airflow, a portion of the airflow is trapped in lateral cavities located in the area of the junction between the tire and the rim, so that the airflow, along the tire and the rim, follows the air that is trapped in the cavities without separating from the wheel, because the air trapped in the cavities circulates in a closed loop in the cavities. The flow remains laminar, without undesirable vortices being formed in the area of the junction zone between the tire and the rim. Thus, the aerodynamic resistance of the tire and of the wheel is reduced. Moreover, advantageously, the spoilers only slightly increase the mass of the tire and of the wheel, because they are small in size. A spoiler, in the context of the invention, is structured and arranged to “spoil”, i.e., to modify, unfavorable air movement across the tire and wheel in motion, thereby lessening air resistance to such motion of the tire and wheel.

According to advantageous but not essential aspects of the invention, such a tire for a cycle wheel can incorporate one or several of the following characteristics, taken in any technically acceptable combination:
each spoiler includes a lateral surface, adjacent to the tread, which is tangent to an outer surface of the tread, and a surface for blocking the closed loop air circulation, which, when the tire is inflated, faces the mounting base;
the blocking surfaces are located above or in the vicinity of an equatorial line of the tire;
thickness on each side of the tire has two maximums located at the top and in the area of the blocking surface, respectively, as well as a minimum located between the two maximums;
in a radial cross section of the tire, when laid flat, the distance separating the two minimums ranges between 70% and 90% of the distance separating the blocking surfaces;
the radial cross section of the tire has a closed contour and, when the tire is deflated and laid flat, a distance between the blocking surfaces ranges between 64 and 100% of a width of the tire;
the radial cross section of the tire has an open contour and, when the tire is laid flat, a distance between the blocking surfaces is less than or equal to 80% of a distance between the beads of the mounting base of the tire, and less than or equal to 75% in a particular embodiment;
each sidewall and the blocking surface of the associated spoiler at least partially demarcate a cavity that is capable of trapping the closed loop air recirculation;
in a radial cross section of the tire, a maximum thickness of each spoiler, measured radially, is greater than or equal to 0.5 mm;
in a radial cross section of the tire, when deflated and laid flat, for each spoiler, an angle, located outside of the tire and defined between a lateral surface of such spoiler, adjacent to the tread, on the one hand, and a portion of the tread adjacent to the lateral surface of this spoiler, on the other hand, ranges between 160 and 175°, and greater than 167° in a particular embodiment;
each spoiler is comprised of one of the lateral ends of an additional element attached on the tire, which forms the tread.

The invention also encompasses a cycle wheel comprising a rim equipped with such a tire.

### BRIEF DESCRIPTION OF DRAWINGS

The invention will be better understood and other advantages thereof will appear more clearly from the following description of a cycle wheel and a tire according to the invention, given only by way of example, with reference to the annexed drawings in which:

FIG. 1 is a partial perspective view of a cycle wheel according to the invention;

FIG. 2 is a cross section along the plane II of FIG. 1;

FIG. 3 is a cross section, similar to FIG. 2, of a tire which is part of the wheel of FIG. 1, in the deflated state and laid flat;

FIG. 4 is a cross section, similar to FIG. 2, of a cycle wheel according to a second embodiment of the invention;

FIG. 5 is a cross section, similar to FIG. 2, of a tire laid flat, which is part of the wheel of FIG. 4;

FIGS. 6 and 7 are cross sections, similar to FIG. 5, of tires according to variations of the second embodiment of the invention; and

FIG. 8 is a cross section of another variation of the second embodiment of the invention.

### DETAILED DESCRIPTION

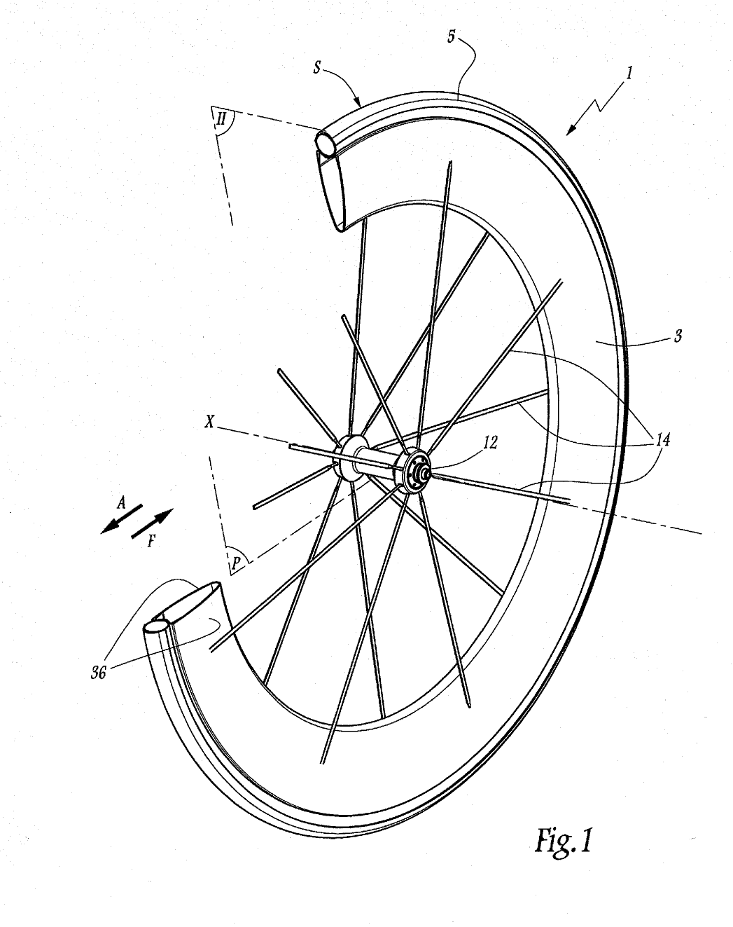

FIG. 1 shows a wheel 1 adapted to fit a cycle, not shown, such as a bicycle or any other type of cycle. During use, the wheel 1 is rotationally movable about an X-axis. The wheel 1 is a spoked wheel, but the invention can be applied to other types of wheels. A portion of the wheel 1 is not shown, so as to reveal the internal geometry of the wheel 1. The wheel 1 includes a rim 3, a tire 5, a hub 12, and spokes 14 which connect the rim 3 to the hub 12. The X-axis is an axis of revolution for the rim 3 and the tire 5.

In the following description, the outer surfaces are those facing outward of the wheel 1, and the inner surfaces those located within the wheel 1.

The apex S of the tire 5 designates an outer peripheral circular zone of the tire 5 that is in contact with the ground when the wheel 1 is in use. The reference character P designates a plane of symmetry of the wheel 1, perpendicular to the X-axis and passing through the apex S of the tire 5.

The reference character A designates a forward direction of the wheel 1, perpendicular to the X-axis and contained in the plane P. The wheel, when advancing along the direction A, is subject to an airflow F, along a direction opposite the direction A. It should be noted that the flow can have a direction F inclined by an angle of incidence relative to the forward direction A; this angle of incidence is due to natural wind that is lateral with respect to the road.

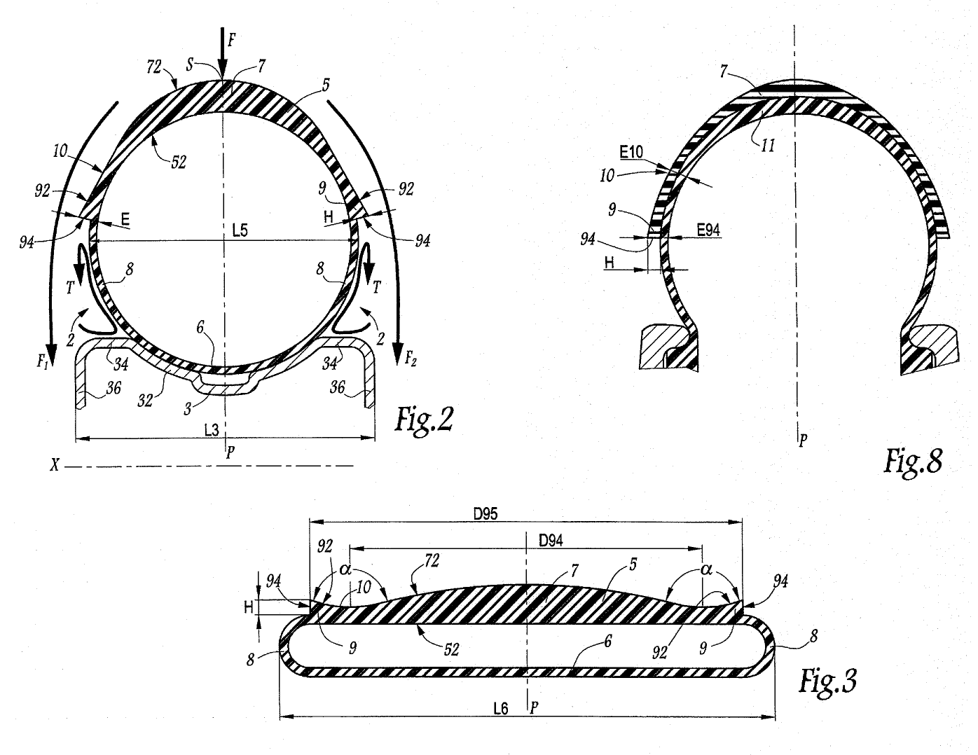

FIG. 2 is a radial cross section of the wheel 1, that is to say, a cross section along a plane II that passes through the X-axis. FIGS. 1 and 2 show the wheel 1 in a configuration in which the tire 5 is assembled to the rim 3 and is inflated, i.e., the illustrated tire being a pneumatic tire.

As shown in FIGS. 1 and 2, the wheel 1 is of the tubular type, that is to say, its radial cross section has a contour closed on itself. When the tire 5 is inflated, its radial cross section is roughly circular, i.e., substantially circular, given its variable thickness. Likewise, the interior surface of the tire, in cross section, can be circular or substantially circular. The tire 5 has a substantially toroidal geometry, and it includes a mounting base 6, a tread 7, and two sidewalls 8 connecting the mounting base 6 to the tread 7. The mounting base 6 is bonded to the rim 3, such as with adhesive. The tread 7 is located in the area of the apex S of the tire 5 and has an outer surface 72. The tread 7 is thicker than the mounting base 6 and the sidewalls 8, and its thickness increases towards the apex S. Each sidewall 8 is spaced from the tread 7 by a spoiler 9, i.e., a deflector or airflow guide, that projects outward of the tire 5 and whose thickness increases as it extends away from the tread 7.

Each of the two spoilers 9 extends over the entire periphery or circumference of the tire 5 and has a lateral surface 92, tangent to the outer surface 72 of the tread 7, and a blocking surface 94, which faces the mounting base 6, i.e., away from the tread 7. In the embodiment of FIG. 2, the final increase in thickness of the spoilers 9, as the spoilers extend away from the tread on opposite sides of the periphery of the tire, ends at the respective surfaces 94. As shown in the radial cross-sectional view of FIG. 2, for example, the distance between the ends of the lateral surfaces 92 of the two spoilers 9, at blocking surfaces 94, perpendicular to the radial plane P, represents the greatest width of the tire in this exemplary illustrated embodiment. The blocking surface 94 shown in this particular illustrated embodiment is substantially perpendicular to the sidewalls 8. The spoilers 9 are located above, radially outward from, an equatorial line of the tire 5. In the context of the invention and along a radial cross section, the equatorial line of the tire can be considered to be the line in which the tire is the widest. In FIG. 2, this line is represented by the arrow marking the maximum diameter L5.

The reference character H designates a maximum height of each spoiler 9, measured radially in the area of the blocking surfaces 94. In the illustrated embodiment, the height H is approximately equal to 1 mm. In a particular embodiment, such as the illustrated embodiment, the height H is greater than or equal to 0.5 mm.

The thickness E of the tire varies between the apex S, where it is maximum, and the various regions of the tire. In the area of the blocking surface 94, the thickness E94 passes through a relative maximum that corresponds to the addition of the height H and the thickness of the underlying portion of the pneumatic tire. Between the apex S and the blocking surface 94, the thickness E passes through a minimum at point 10. In the embodiment illustrated in FIGS. 1 to 3, the thickness at the apex is about 3.5 mm, the thickness E94 is about 1.6 mm, and in the location of the minimum 10, the thickness E10 is about equal to 1.2 mm. The presence of the minimum thickness 10 is one of the means that make it possible to provide the spoilers with a shape structured and arranged to deflect the airflows F1 and F2. In particular non-limiting embodiments, the thickness of the tire can remain constant, or substantially constant, between each of the spoilers 9, i.e., such as the blocking surfaces 94, and respective portions of the sidewalls 8 that engage the rim 3.

The distance D95 separating the two minimums 10 ranges between 70 and 90% of the width between the blocking surfaces D94, and between 74 and 78% in a particular embodiment. Good results are obtained with a distance D95 equal to 76% of the distance D94.

The rim 3, having a width L3, has two lateral walls 36, shown partially in FIG. 2, which are connected to one another by a peripheral portion 34 including a radially outward concave central portion 32. The mounting base 6 is bonded, by adhesive, e.g., to the central portion 32 of the peripheral portion 34 of the rim 3.

The reference numeral L5 designates a width of the tire 5, measured parallel to the X-axis, in the area of the equatorial line. The width L5 of the tire 5 is less than the width L3 of the rim 3. The implementation of the invention yields particularly good results in the case of wheels in which the rim is wider than the tire (L3>L5). However, the implementation of a tire according to the invention can improve the aerodynamics of a wheel whose rim is of the same width as or narrower than the tire.

In the area of the junction between the tire 5 and the rim 3, the wheel 1 has two lateral cavities 2 each demarcated by the peripheral portion 34 of the rim 3, one of the sidewalls 8 of the tire 5, and the blocking surface 94 of one of the spoilers 9. Because the width of the rim is greater than the largest width L5 of the tire, when inflated, and because the spoiler is located near or above the equatorial plane of the tire, the volume of the lateral cavities 2 is relatively substantial. In particular, the depth of the cavities is substantially equal to the depth of the lips of the flanges, in the case of a wire bead tire, i.e., a tire for a clincher rim, and to the depth of the peripheral portion 34, in the case of a tubular tire.

FIG. 3 shows a radial cross section of the tire 5, when deflated and laid flat. In this configuration, an inner surface 52 of the tire 5 comprises two parallel planar portions, which are part of the mounting base 6 and of the tread 7, respectively, and are connected to one another by the sidewalls 8, which are curved. This representation is schematic because, in practice, when the tire 5 is laid flat, the tread 7 comes in contact with the mounting base 6.

The reference numeral D94 designates a distance, measured parallel to the X-axis, between the blocking surfaces 94 of the spoilers 9. In the configuration of FIG. 3, the blocking surface 94 of each spoiler 9 is parallel to the plane P. The reference numeral L6 designates a width of the tire 5, measured parallel to the X-axis. In a particular embodiment, the distance D94 ranges between 64 and 100% of the width L6. Good results are obtained with a value D94 ranging between 69 and 74%.

For each spoiler 9 an angle α is located outside of the tire 5, measured between the lateral surface 92 of the spoiler 9 and one end of the tread 7 adjacent to the spoiler 9. Because the junction zone between the lateral surface 92 of each spoiler 9 and the tread 7 is rounded, the measurement of the angle α is taken on both sides of this rounded zone. The angle α is approximately equal to 150°. The more the angle α decreases, the more the spoilers 9 are inclined outward and project relative to the tread 7. In particular embodiments, the angle α can range between 160 and 175°. In other embodiments, the angle α can be greater than 167°.

During use, when the airflow F reaches the apex S of the tire 5, it separates into two lateral airflows F1 and F2 which, as shown in FIG. 2, extend along the tire 5 and the lateral walls 36 of the rim 3, on both sides of the wheel 1. When the lateral airflows F1 and F2 extend along the wheel 1, a portion of the airflows F1 and F2 rushes into each cavity 2 and recirculates in these cavities 2, as indicated by the arrows F in FIG. 2. In other words, air is trapped in the cavities 2 and circulates in a closed loop within the cavities 2. More specifically, the air that is trapped in each cavity 2 flows along the peripheral portion 34 of the rim 3, and then along the corresponding sidewall 8 of the tire, in the direction of the corresponding spoiler 9. Then, the blocking surfaces 94 of the spoilers 9 obstruct the air trapped in the cavities 2, so that the air is redirected toward the peripheral portion 34. Therefore, the spoilers 9 function to retain a closed loop air circulation in the two cavities.

Due to the spoilers 9, the lateral airflows F1 and F2 remain laminar when they extend past and beyond the interface between the tire 5 and the rim 3, because trapped air fills the cavities 2. Thus, the lateral airflows F1 and F2 can again attach themselves to the sidewalls of the rim and do not separate from the wheel 1; they do not create undesirable vortices generating a loss of energy.

In a particular embodiment, the spoilers 9 are located in the area of a zone of separation of the lateral airflows F1 and F2, that is to say, in the vicinity of the location in which the airflows F1 and F2 would separate from the tire 5 if the latter were not provided with spoilers 9. The spoilers 9 can also be located slightly downstream of the separation zone.

The lateral surfaces 92 of the spoilers 9 are tangent to the outer surface 72 of the tread 7; the lateral airflows F1 and F2 do not separate and remain laminar when extending along the tread 7 and the spoilers 9. If the angle α is too small, a break can appear between the outer surface 72 of the tread 7 and the lateral surface 92 of each spoiler 9, which can cause an overly substantial and rapid deviation of the air flow, thereby increasing the drag by increasing pressure on the lateral surfaces 92.

In the case in which the tire 5 is not be provided with spoilers 9, the lateral airflows F1 and F2 would enter into the cavities 2, thereby causing the separation of lateral airflows F1 and F2 and the formation of vortices F which then attempt to rise as high as possible along the sidewalls of the tire, because they are not stopped by the boundaries of the spoiler 9; by rising in this manner, they reduce the laminar zone and thus increase the drag on the wheel.

The spoilers 9 do not fill the cavities 2. Conversely, the blocking surfaces 94 of the spoilers 9 demarcate the upper portion of the cavities 2 to enable recirculation of the air in the cavities 2.

Optionally, the tire is comprised of a carcass on which an additional element, which forms the tread 7, is bonded. In such a case, the spoilers 9 are comprised of the lateral ends of this attached element.

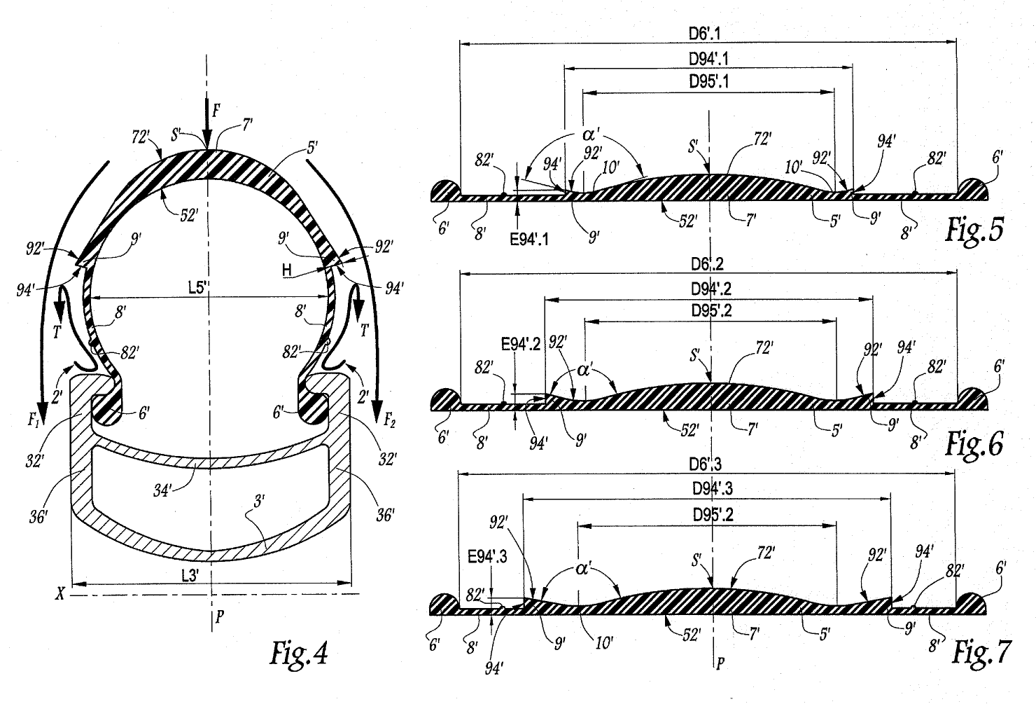

FIGS. 4 and 5 correspond to a second embodiment of the invention, in which the elements that are similar to those of FIGS. 1 to 3 have the same reference numerals, followed by a prime symbol.

FIG. 5 shows a radial cross section of a wheel in a configuration in which a tire 5′ is assembled to a rim 3′ with an inflated inner tube not shown. The tire 5′ is a wire bead tire, or a clincher tire, that is to say, its radial cross section has a contour open in the direction of the X-axis. As a result, the tire 5′ is substantially toroidal. The edges of the tire 5′ turned toward the X-axis are each provided with a bead 6′ which contains a stiffening rod, not shown. The beads 6′ constitute a mounting base of the tire 5′. The tire 5′ includes a tread 7′ and two sidewalls 8′ that connect the tread 7′ to the beads 6′. The tread 7′ is located in the area of the apex S′ of the tire 5′ and has an outer surface 72′. The tread 7′ is thicker than the sidewalls 8′, and its thickness increases towards the apex S. Each sidewall 8′ is separated from the tread 7′ by a spoiler 9′ that projects outward of the tire 5′ and whose thickness increases as it extends away from the tread 7′. Each spoiler 9′ has a lateral surface 92′, tangent to the outer surface 72′ of the tread 7′, and a blocking surface 94′ facing the beads 6′. The blocking surface 94′ is perpendicular to the sidewalls 8′. The perpendicular or substantially perpendicular characteristic of the blocking surface, relative to the sidewalls, makes it possible to ensure a well-defined transition between the spoiler and the sidewalls, in contrast with the transition between the spoiler and the tread. Therefore, spoilers can be made with blocking surfaces that form, together with the sidewall 8, an angle ranging between 60° and 120° or, in other embodiments, between 75° and 105°.

The rim 3′, having a width L′3, includes a hollow casing 34′ comprising two lateral walls 36′. The ends of the lateral walls 36′, located on the side of the tire 5′, are provided with L-shaped flanges 32′, which include inwardly projecting lips. The beads 6′ of the tire 5′ are fixed to the rim 3′ by means of the flanges 32′. In non-limiting embodiments, when the tire 5′ is inflated, the portion of its radial cross section that is radially outward of, i.e., which extends away from, the rim-engaging portions of the tire, can be substantially circular, given its variable thickness. Likewise, the interior surface of the tire in the portions that extend radially away from the rim-engaging portions, in cross section, can be circular or substantially circular.

The rim 3′ can be fixed to an element, not shown, whose geometry is similar to that of the rim 3 shown in FIG. 1.

The sidewalls 8′ are each equipped with an optional centering indicator 82′, located between the beads 6′ and the spoilers 9′. The centering indicators 82′ make it possible to correctly position the beads 6′ of the deflated tire 5′ between the flanges 32′ of the rim 3′, during assembly of the wheel 1′.

The reference numeral L5′ designated a width of the tire 5′, measured parallel to the X-axis, in the area of an equatorial line of the radial cross section of the tire 5′. The width L5′ of the tire 5′ is less than the width L3′ of the rim 3′. In the case of a wire bead tire, or clincher tire, the position of the equatorial line can change for the same tire depending upon the spacing of the flanges of the rim on which it is mounted. Thus, the spoilers can be positioned above the equatorial line or near it, but slightly below.

The wheel 1′ has, in the area of the junction between the tire 5′ and the rim 3′, two lateral cavities 2′ each demarcated by one of the flanges 32′ of the rim 3′, one of the sidewalls 8′ of the tire 5′, and the blocking surface 94′ of one of the spoilers 9′.

FIG. 5 shows a radial cross section of the tire 5′ separated from the rim 3′ and laid flat. In this configuration, the inner surface 52′ of the tire 5′ is planar and perpendicular to the plane P.

The reference numeral D94′.1 designates a distance, measured perpendicular to the plane P, between the blocking surfaces 94′ of the spoilers 9′. In the configuration of FIG. 5, the blocking surface 94′ of each spoiler 9′ is parallel to the plane P. The reference numeral D6′.1 designates a distance between the beads 6′ of the tire 5′, measured perpendicular to the plane P. The distance D94′.1 is approximately equal to 60% of the distance D6′.1.

For each spoiler 9′ an angle α′ is located outside of the tire 5′, measured between the lateral surface 92′ of each spoiler 9′ and one end of the tread 52′ adjacent to the spoiler 9′. In FIGS. 5 to 7, only the angle α′ located on the left of the plane P is shown. The angles α′ of the tire 5′ are equal and are approximately 150°. The angle α′ can be greater than the angle α and range between 160 and 175°, and greater than 167° in particular embodiments.

The reference character H designates the maximum height of each spoiler 9′, measured radially in the area of the blocking surface 94′. The maximum height H is approximately equal to 0.5 mm. In particular embodiments the maximum height H is greater than or equal to 0.5 mm. In FIGS. 2, 3, 4, and 8, only the maximum height H of one of the spoilers 9, 9′ is shown, but the maximum height of the other spoiler 9, 9′ is identical.

As shown in FIG. 5, the thickness E of the tire has two maximums, one in the area of the apex S′ and the other in the area of the blocking surface 94′, between which there is a minimum thickness 10′. The distance D95′.1 separating the two minimums 10′ is about 90% of the distance D94′.1 separating the two blocking surfaces 94′. With respect to the distance D6′.1, the ratio is in the range of 40 to 60%. In the example shown, this ratio is about 50%. In particular non-limiting embodiments, as shown in FIG. 4, e.g., the thickness of the tire can remain constant, or substantially constant, between each of the spoilers 9′, i.e., such as the blocking surfaces 94′, and respective portions of the sidewalls 8′ that engage the rim 3.

When the wheel according to the second embodiment is subject to an airflow F similar to that described with reference to the first embodiment, the same phenomena as those described for the first embodiment are observed. Thus, a portion of the lateral airflows F1 and F2 forms a vortex T that is trapped in the cavities 2′ and recirculates in the cavities 2′ due to spoilers 9′, as indicated by the arrows in FIG. 4.

FIGS. 6 and 7 illustrate variations of the embodiment of FIGS. 4 and 5. Thus, in FIGS. 6 and 7, the elements similar to those of FIGS. 4 and 5 have the same reference numerals.

The tires 5′ of FIGS. 6 and 7 are distinguished from that of FIGS. 4 and 5 by the extent of the distance, measured perpendicular to the plane P, between the blocking surfaces 94′: one switches from the distance D94′.1, shown in FIG. 5, to the distance D94′.2, shown in FIG. 6, which is greater than the distance D94′.1, even to the distance D94′.3, shown in FIG. 7, which is even greater. Thus, the distance D94′.2 is approximately equal to 66% of the distance D6′.2 and the distance D94′.3 is approximately equal to 75% of the distance D6′.3. In any case, the distance between the blocking surfaces 94′, in a particular embodiment, is less than or equal to 80% of the distance D6′.1. Furthermore, the distances D95′.2 and D95′.3 separating the thickness minimums 10′ are approximately equal to 80 and 70% of the distances D94′.2 and D94′.3, respectively.

The tires 5′ of FIGS. 6 and 7 are also distinguished from that of FIGS. 4 and 5 by the height H of the spoilers 9′. The height H can be greater than the thickness E8′ of the sidewalls. In practice, for a bicycle tire, in particular a tire intended for sporting use on the road, the thickness E8′ can range between 0.8 mm and 2 mm. The height H of the spoiler can range between 0.5 and 3 mm.

FIG. 8 shows another variation of the second embodiment of the invention and shows the internal construction of the tire in greater detail. In particular, FIG. 8 shows that such tire construction includes a carcass 11, on which the tread 7 is arranged. In practice, the carcass 11 and the tread 7 can be affixed by bonding, such as with an adhesive bond, or directly when both the carcass and the tread are vulcanized together.

This alternative embodiment is characterized by a very small difference in thickness between the thickness E94 and the thickness E10; this difference can be less than 0.1 mm.

A tire and a wheel according to the invention have an improved aerodynamic resistance, without overly increasing the mass of the tire and wheel. Indeed, the spoilers 9 and 9′ are relatively small in size, which adds only a small amount of material to the tire. Moreover, the positioning of the spoilers above the equatorial line of the tire, or close to it, means that they do not interfere with the mounting of the tire on the rim. Indeed, in all of the embodiments, the spoilers are relatively spaced from the flanges or the peripheral portion of the rim.

In addition, the invention disclosed herein by way of exemplary embodiments may be suitably practiced in the absence of any element or structure which is not specifically disclosed herein.

1. A tire for a cycle wheel, said tire having a substantially toroidal geometry and comprising:
a mounting base structured and arranged to be fixed to a rim of the wheel;
a tread structured and arranged to contact the ground;
a pair of opposite sidewalls connecting the mounting base to the tread;
a pair of spoilers, each of the pair of spoilers positioned between a respective one of the pair of sidewalls and the tread;
each of the pair of spoilers is structured and arranged to retain a closed loop air circulation during advancing movement of the tire when mounted on the wheel.

2. A tire according to claim 1, wherein:
each of the pair of spoilers includes a lateral surface, adjacent to the tread;
each of the lateral surfaces is tangent to an outer surface of the tread;
the tire is a pneumatic tire constructed to be inflatable;
when the tire is inflated, a blocking surface for blocking the close loop air circulation faces the mounting base, away from the tread.

3. A tire according to claim 2, wherein:
the blocking surfaces are located above or in the vicinity of an equatorial line of the tire.

4. A tire according to claim 2, wherein:
each sidewall of the tire has a thickness including two maximums;
one of the two maximums is located at an apex of the tire;
another of the two maximums is located in an area of the blocking surface;
the thickness of each of the sidewalls of the tire has a minimum located between the two maximums.

5. A tire according to claim 4, wherein:
in a radial cross section of the tire, uninflated and laid flat, a distance separating the two minimum thicknesses is between 70% and 90% of a distance separating the blocking surfaces.

6. A tire according to claim 4, wherein:
a radial cross section of the tire has a closed contour;
in the radial cross section of the tire, when the tire is deflated and laid flat, a distance between the blocking surfaces is between 64% and 100% of a width of the tire.

7. A tire according to claim 4, wherein:
a radial cross section of the tire has an open contour;
the mounting base of the tire comprises a pair of spaced-apart beads structured and arranged to be engaged with flanges of the rim;
in the radial cross section of the tire, laid flat, a distance between the blocking surfaces is less than or equal to 80% of a distance between the beads of the mounting base of the tire.

8. A tire according to claim 7, wherein:
in the radial cross section of the tire, laid flat, the distance between the blocking surfaces is less than or equal to 75% of the distance between the beads of the mounting base of the tire.

9. A tire according to claim 2, wherein:
each of the sidewalls and the blocking surface of a respective one of the pair of spoilers at least partially demarcates a cavity structured and arranged to trap the closed loop air recirculation.

10. A tire according to claim 1, wherein:
in a radial cross section of the tire, a maximum height of each one of the pair of spoilers, measured radially, is greater than or equal to 0.5 mm.

11. A tire according to claim 1, wherein:
in a radial cross section of the tire, uninflated and laid flat, each of the pair of spoilers defines an angle, located outside of the tire, between the following:
a lateral surface of the spoiler adjacent to the tread; and
a portion of the tread adjacent to the lateral surface of the spoiler;
the angle has a value between 160 and 175°.

12. A tire according to claim 1, wherein:
in a radial cross section of the tire, uninflated and laid flat, each of the pair of spoilers defines an angle, located outside of the tire, between the following:
a lateral surface of the spoiler adjacent to the tread; and
a portion of the tread adjacent to the lateral surface of the spoiler;
the angle has a value greater than 167°.

13. A tire according to claim 1, wherein:
each of the pair of spoilers is comprised of a lateral end of a respective additional element attached on the tire, said additional elements forming the tread.

14. A tire according to claim 1, wherein:
each of the pair of spoilers covers an entire circumferential periphery of the tire.

15. A tire according to claim 1, wherein:
surfaces of the pair of spoilers define a greatest width of the tire, said width extending perpendicular to a radial plane.

16. A tire according to claim 1, wherein:
each of the pair of spoilers extends from the tread in respective directions on the opposite sidewalls of the tire, toward rim-engaging portions of the tire;
each of the pair of spoilers is spaced from a respective one of the rim-engaging portions of the tire;
each of the opposite sidewalls of the tire has an at least substantially constant thickness between a respective one of the pair of spoilers and a respective one of the rim-engaging portions of the tire.

17. A tire according to claim 16, wherein:
the tire is a pneumatic tire constructed to be inflatable;
when the tire is inflated, each of the pair of spoilers comprises a blocking surface located in the vicinity of, or radially outward from, an equatorial line of the tire in a radial transverse cross section;
each of the blocking surfaces of the tire is spaced from a respective one of the rim-engaging portions of the tire.

18. A tire according to claim 1, wherein:
the tire is a pneumatic tire constructed to be inflatable;
in a radial transverse cross section when the tire is inflated, an interior surface portion of the tire, extending radially away from portions rim-engaging portions of the tire, extends in a circular arc or a substantially circular arc.

19. A wheel for a cycle, said wheel comprising:
a rim;
a tire having a substantially toroidal geometry and comprising:
a mounting base structured and arranged to be fixed to a rim of the wheel;
a tread structured and arranged to contact the ground;
a pair of opposite sidewalls connecting the mounting base to the tread;
a pair of spoilers, each of the pair of spoilers positioned between a respective one of the pair of sidewalls and the tread;
each of the pair of spoilers structured and arranged to retain a closed loop air circulation during advancing movement of the tire when mounted on the wheel;
the mounting base of the tire being fixed to the rim.
